(19) United States
(12) Patent Application Publication
(10) Pub. No.: US 2008/0302241 A1
(43) Pub. Date: Dec. 11, 2008

(54) Structural Principle of an Exhaust Gas Purification Installation, and Associated Method For Purifying an Exhaust Gas

(75) Inventors: Andrei Bologa, Stutensee (DE); Thomas Wascher, Heidelberg (DE); Hanns-Rudolf Paur, Karlsruhe (DE); Klaus Woletz, Eggenstein-Leopoldshafen (DE)

Correspondence Address: VENABLE LLP, P.O. BOX 34385, WASHINGTON, DC, 20043-9998, US

(73) Assignee: Forschungszentrum Karlsruhe GmbH, Karlsruhe (DE)

(21) Appl. No.: 11/659,001

(22) PCT Filed: May 6, 2005
(86) PCT No.: PCT/EP05/04939

§ 371 Date: Jan. 31, 2007

(30) Foreign Application Priority Data
Jul. 31, 2004 (DE) 10 2004 037 286.1

(51) Int. Cl. B03C 3/16; B03C 3/14

(52) U.S. Cl. 95/71; 96/50

(57) ABSTRACT

In an exhaust gas cleaning system, a built-in cleaning section is embodied as an upright U, in which a first leg includes an ionizing zone to ionize particles or aerosols carried in the gas. The gas flows from above into the first leg and downward in a direction of gravity through the ionizing zone. A second leg includes a collector to separate the particles or aerosols from the gas flow, which flows into and through the collector in a direction from below and upward, counter to the direction of gravity. A spraying device is mounted above the collector to rinse the collector. A transition from the first to the second leg includes a connecting zone including a container to collect the particles or aerosols separated of the gas, which container includes a discharge pipe disposed at a lowest point of the container to discharge the liquid enriched with the particles.

The invention relates to the structural principle of an exhaust gas purification installation and to a method for purifying an exhaust gas.

The precipitating of submicron particles from exhaust gases by using cyclone separators, scrubbers, and bag filters is difficult. The electrostatic precipitator is one of the most effective devices/components of a gas purification installation for precipitating fine particles (see, for example, reference DE 101 32 582).

In most cases, a gas purification installation takes the form of a built-in section in a gas flow channel and comprises the following structural components, which follow successively in flow direction:
A zone for the ionizing of particles/aerosols carried along with the gas, the ionizer zone, followed by a connecting or transition zone which, in turn, is followed by a collector zone for precipitating the therein electrically neutralized particles/aerosols and, finally, a spraying device for spraying the collector with a rinsing liquid.

The electrostatic precipitation is a physical process, by means of which particles are electrically charged and are then separated out/precipitated out of the gas under the effect of an external electrical field. In single-stage electrostatic precipitators, the electrical field generates a corona discharge for charging the particles and attracting them in the direction of the wall, so that they can finally be removed from there. In a two-stage electrostatic precipitator, the particles are generally charged and precipitated in two differently dimensioned external electrical fields.

The concept involves a method and a device to ensure the effective precipitating of particles, to lower the start-up and operating costs for the electrostatic precipitator, and to simplify the structural design (see DE 102 44 051). The particles are charged by means of a corona discharge and are then removed in an external, field-free collector. The precipitator consists of the charging device, the casing connections, and the device for precipitating out. The charging device comprises a grounded injector plate and high-voltage needle electrodes which are positioned centrally in the injectors. The particles are charged in the direct current corona discharge. The precipitating device consists, for example, of a grounded tube-bundle collector. The method and the precipitator are distinguished over the standard, two-stage electrostatic precipitator in that no separate electrical field is required for the precipitation in the collection zone, thereby making possible a compact design for the precipitator.

The method involves the following steps:
The particle-loaded gas to be cleaned enters the opening of the exhaust gas cleaning installation and then flows into the injectors in the electrically grounded plate. This plate is positioned perpendicular to the flow axis. The exhaust gas flows through the ionizer where the particles are electrically charged by means of the corona discharge. The ionizer is positioned between the high-voltage electrodes and the internal surface of the grounded injectors. The high-voltage electrodes are aligned and mount on a high-voltage grid which is installed downstream of the injector plate on the installation casing, so as to be electrically insulated. The gas loaded with electrically charged particles then passes through the connecting region of the installation, which connects the ionizer and the precipitating zone and, finally, is discharged from the installation into the connected gas flow channel.

According to the known method, the gas flows in the same direction through the charging unit/charging zone, the connecting section, and the zone for precipitating. With the exhaust gas cleaning installation described in reference DE 101 32 582 C1, the gas to be cleaned flows in the direction of gravity, whereas the gas flows in the direction counter to the gravity for the installation described in reference DE 102 44 051 C1.

Even though the method used and the exhaust gas cleaning installations disclosed therein effectively clean the gas that flows through, there are some problems. In the installation described in reference DE 101 32 582, the loaded particles are precipitated out in the tube-bundle collector by forming a liquid film. With higher aerosol concentrations, the film flows in the direction of gravity along the tube surfaces and drops can form when it leaves the tubes, which can again enter the cleaned gas flow, thereby reducing the degree of precipitation obtained with the installation.

When cleaning a gas with high particle concentration with the aid of the exhaust-gas cleaning installation described in reference DE 102 44 015 C1, a portion of the liquid film drips from the tube bundle collector onto the charging unit, provoking a spark discharge thereon which reduces the degree of precipitation. In the same way, a portion of the particles is precipitated out onto the surface of the high-voltage grid and the thereon mounted high-voltage electrodes. These particles form small droplets at the electrode tips, thereby decisively changing the intended corona discharge, provoking spark-over, worsening the particle charging process, and reducing the degree of precipitation.

It is the object of the present invention to provide an exhaust gas cleaning installation which can be operated over a long period of time in such a way that the predetermined degree of precipitation does not change, or at least not to a degree worth mentioning.

This object is solved with the design principle described in claim 1 for the exhaust gas cleaning installation consisting of an electrostatic charging device, a transition zone, and a particle precipitation device, as well as with the method described in claim 4 for operating this installation.

The exhaust gas cleaning installation, in the form of a built-in section in a gas flow channel, is embodied in the shape of an upright standing U. One leg contains the zone for ionizing of the particles/aerosols carried along by the gas, called the electrostatic charging zone or, abbreviated, the ionizer. The transition from one leg to the other, the connecting zone, forms the collection basin/container for the particles precipitated/separated out of the gas flow and dripping down from the collector. At its lowest point, at least one discharge duct is installed for discharging the liquid enriched with particles, wherein discharge ducts can also be installed at higher locations on the collection container if necessary. The second leg contains the collection zone in which the particles are precipitated out of the gas flow and are electrically neutralized, so that they can be discharged/can flow off toward the bottom along with the rinsing liquid.

The collector zone consists of at least one collector, or several successively arranged collectors in flow direction, wherein each separate collector consists of a tube bundle group with at least one tube bundle.

It is critical for the particle-laced gas to be cleaned to flow into the installation leg containing the ionizer, in the direction of gravity, meaning from the top toward the bottom. During the passage, the particles are electrically charged by means of a corona discharge. The polarity can be selected, but is frequently a negative charge. The ionizer consists of the injector plate, connected to a defined electrical reference potential which in most cases is the ground potential, and the high-voltage grid that in most cases is connected to negative potential with thereon installed and aligned electrodes. For the intended ionization it is important that the electrodes project with their exposed ends from below into the respectively assigned injectors (claim 2) since this is the only way to ensure that no drops form on the electrodes, particularly the electrode tips, which could cause a sensitive change in the corona discharge. Drops that may form on the electrodes immediately flow down toward the high-voltage grid and, supported by the gas flow, drip downward from the high-voltage grid to be collected in the collection container and then discharged. The collection container is also connected to reference potential to prevent an electrical charging, wherein the reference potential here is simply the ground potential to avoid the need for additional structural measures (for example the protection against accidental contact).

The particle-loaded exhaust gas leaving the ionizer is guided into the connecting zone and, once it has passed through this zone, is redirected into the second leg to flow perpendicular from the bottom toward the top, meaning counter to the direction of gravity. The portion of the still electrically charged particles/aerosols that drips off, on the other hand, is collected in the collection container located in the connecting zone.

As previously mentioned, the exhaust gas flows counter to the direction of gravity through the collector for the cleaning and/or the precipitating of particles in the collector, meaning it flows from the bottom toward the top. All or at least most of the particles/aerosols are deposited along the collector walls where they are neutralized electrically and flow off in the direction of gravity in the form of a liquid film loaded with particles, together with a rinsing liquid that is sprayed counter to the gas flow from above onto the collector, so that they can subsequently drip into the collection container in the connecting zone. The collector comprises at least one tube bundle, positioned on a grid that is also connected to electrical reference potential (claim 3). This grid can, of course, be sprayed from the bottom if such a measure is helpful. However, it is standard procedure to spray the collector from above.

The gas processed in this way then leaves the collector freed of particles and continues to flow as cleaned gas through the connected flow channel.

With the above-described exhaust gas cleaning installation and the method for operating it, it is possible to achieve the goal of effectively cleaning an exhaust gas of fine particles, mainly submicron particles in solid or liquid form.

The exhaust gas cleaning installation is distinguished by its design in the form of an upright standing U. With this installation, the cleaning method can be realized with high efficiency and without problems over a long period of time because the exhaust gas flow is conducted so as to prevent the forming of drops at the exposed electrode ends in the injectors. As a result, the particle ionizing between exposed electrode end and injector inside wall during the corona discharge always occurs as planned, meaning it is consistent. The effectiveness of the particle/aerosol precipitation is therefore complete or nearly complete. The installation as a built-in component of the flow channel has a compact and technically robust design, is easy to monitor because of the three components and/or the four components with the spraying device, and is also easy to install and maintain. The flow direction for the exhaust gas in the ionizing zone is counter to the flow direction in the collector zone.

The materials for constructing the exhaust gas cleaning installation are selected on the basis of the process to be realized. Whether dielectric or electrically conducting depends on the type of exhaust gas and the particles carried along. It should be possible to select the electrical and [sic] conditions and it should be possible to carry out the cleaning process over long periods of time without corrosion appearing on the installation inside.

The cleaning installation can be equipped for the cleaning of exhaust gases in the form of environmental air, flue gases, damp gas, dry gas and hot gas. The only requirement is that the particles carried along in the exhaust gas flow, whether liquid or solid, can be ionized, meaning electrically charged. Particularly suitable is an exhaust gas cleaning installation for precipitating out submicron particles with a diameter range of D<1 μm, which are otherwise difficult to precipitate out.

With the aid of the schematic drawing of the exhaust gas cleaning installation, this installation and the method realized therewith are explained in further detail, wherein:

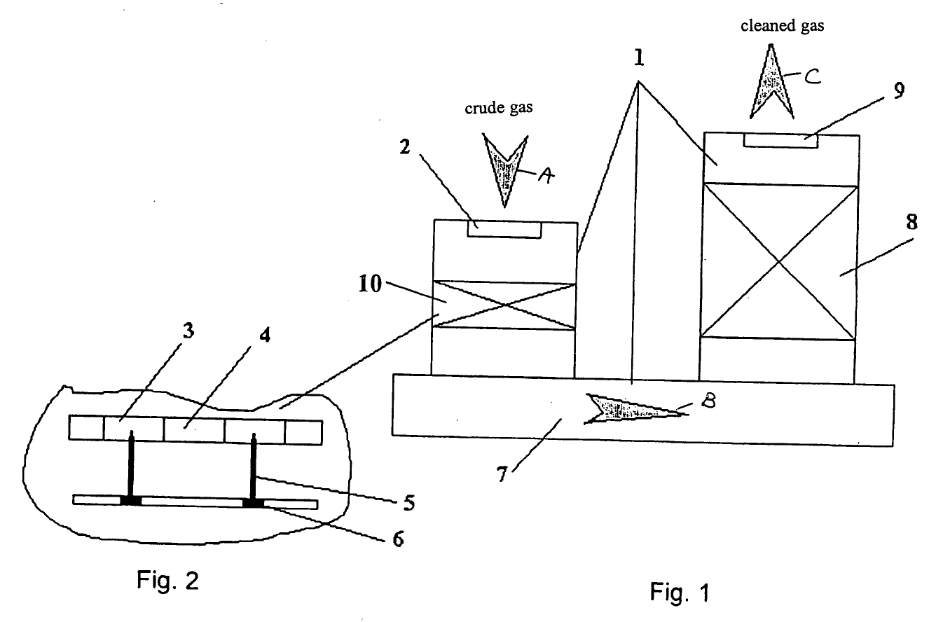

FIG. 1 shows the installation layout;

FIG. 2 shows an enlarged view of the ionizing zone.

In FIG. 1, the exhaust gas to be cleaned flows from the top into the opening 2 of the exhaust gas cleaning installation 1 and then flows in the direction of gravity downward and through the ionizer 10. There, the particles/aerosols are ionized, meaning charged with a predetermined polarity by means of a corona discharge, mostly with a negative charge.

FIG. 2 shows detailed views of the ionizer 10, wherein the sectional views show two injectors 3 in the metal plate that is connected to ground potential, the injector plate 4 of stainless steel or copper or an electrically conductive composite material of carbon, in any case a material that is inert to the processing environment. Respectively one electrode tip 5 in this case projects into each injector. All electrode tips are installed so as to be aligned on the high-voltage grid 6. The high-voltage grid 6 is mounted on the casing wall for the installation, so as to be electrically insulated. The high-voltage grid 6 is connected to the high-voltage potential generated in a supply unit via a bushing in the casing wall (for example see DE 101 32 528 C1 or DE 102 44 051 C1). The high-voltage potential can generally be adjusted at the supply unit and its polarity is selected based on the process to be realized.

The particles/aerosols are electrically charged once the exhaust gas has passed through the ionizer 10. The exhaust gas flow is then redirected to flow in horizontal direction into the connecting zone 7 and through the bottom of the U until it is redirected again to flow from the bottom into the other leg 8, that is to say counter to the direction of gravity. The connecting piece 7 functions as collection zone for the particles precipitated out of the gas flow and for the liquid film loaded with particles/aerosols, which run off from the collector 8.

The exhaust gas with the electrically charged particles enters the collector 8 which is connected to ground. While flowing from the bottom toward the top, the electrically charged particles are pulled against the tube walls, which attract the particles because of the electrical connection of the collector 8 to the ground potential, and are deposited thereon. In the process, the electrical charge is removed and the particles are electrically neutralized.

For the rinsing operation, the collector 8 is normally sprayed from the top (not shown in FIG. 1), so that the particles deposited on the collector walls are washed down along with the rinsing liquid and are collected in the connecting zone 7, embodied as a collection container 7, from which they are subsequently discharged via a connected pipe.

Following the discharge from the collector 8, the cleaned exhaust gas continues to flow toward the top where it leaves the exhaust gas cleaning installation 1 at the leg exit 9 and enters the attached flow channel where it continues to flow, or is vented directly to the environment.

The effectiveness of the exhaust gas cleaning installation 1 and the method used were tested experimentally in a pilot installation. The pilot installation consisted of an injector plate with 61 injectors and one tube bundle collector. The installation was operated with a direct voltage of 9.5-10.5 kV for the corona discharge, wherein the corona current ranged from 4.5 to 5.5 mA. The ionizer was provided with a hollow-cylindrical casing, in the same way as the collector. The particle mass concentration in the exhaust gas ranged from 70-110 mg/Nm³.

In cases where the exhaust gas flow in the ionizer and in the collector zone was counter to the direction of gravity, the effectiveness of the precipitator ranged from 82-86%.
An effective precipitation of between 79-83% was achieved if the direction of the exhaust gas flow in the ionizer and in the collector zone was the same as the direction of gravity.
The effective precipitation ranged from 95-97% if the exhaust gas flow direction in the ionizer was the same while the flow direction in the collector zone was counter to the direction of gravity.

The considerable improvement in the degree of precipitation can be traced back to the U-shaped structural principle and the steadiness of the corona discharge in the ionizer.

### LIST OF REFERENCE NUMBERS

1 section
2 opening
3 injector
4 injector plate
5 high-voltage electrode
6 high-voltage grid
7 connecting zone, collection container/vessel
8 collector zone, particle precipitator
9 exit opening
10 ionizer

1. An exhaust gas cleaning system comprising a built-in cleaning section in a gas-flow channel,
the cleaning section being embodied in the shape of an upright U and comprising:
a first leg comprising an ionizing zone or ionizer to ionize at least one of particles or aerosols carried in the gas, the gas to be cleaned flowing from above into the first leg downward in a direction of gravity through the ionizing zone or ionizer;
a second leg comprising a collector zone or collector to at least one of precipitate out or separate out the particles or aerosols from the gas, the gas flowing into and through the collector zone in a direction from below and upward, counter to the direction of gravity;
a spraying device mounted above the collector zone to rinse out the collector zone with a liquid; and
a transition from the first leg to the second leg including a connecting zone including a collection container to collect the particles or aerosols precipitated out or separated out from the gas flow, which collection container includes at least one discharge pipe disposed at a lowest point of the collection container to discharge the liquid enriched with the particles.

2. The system according to claim 1, wherein at least one of the ionizing zone or ionizer comprises:
an injector plate connected to an electrical reference potential and a high-voltage grid and including injectors; and
high-voltage electrodes disposed on the high-voltage grid and aligned so that each high-voltage electrode projects into a corresponding injector from below.

3. The system according to claim 2, wherein the collector zone comprises at least one group of tube bundles.

4. A method for cleaning an exhaust gas in the exhaust gas cleaning system of claim 1 comprising:
ionizing an exhaust gas which flows downstream from a supply channel into the first leg and through the ionizing zone or ionizer, in the direction of gravity;
one of:
re-directing the gas leaving the ionizing zone in the connecting zone to flow into the second leg, counter to the direction of gravity and perpendicular from the bottom toward the top, or
trickling out at least a portion of the particles or aerosols collected in the connecting zone;
precipitating out or separating out the exhaust gas in the collector zone which gas flows counter to the direction of gravity from the bottom toward the top through the collector zone, wherein the particles or aerosols are being electrically neutralized; and
spraying the liquid from the spraying device from above and onto the collector so that the neutralized particles or aerosols flow off, counter to the gas flow, in the direction of gravity as a liquid film loaded with the particles or aerosols which drips into the connecting zone and into the collection container;
wherein the cleaned gas flows out of the second leg.

5. The system as set forth in claim 1, wherein the collector zone includes a plurality of collectors successively arranged in the flow direction.

6. The system as set forth in claim 5, further including:
spraying devices, each spraying device being disposed between adjacent collectors.
